(19) United States
(12) Patent Application Publication
(10) Pub. No.: US 2007/0283189 A1
(43) Pub. Date: Dec. 6, 2007

(54) Method and a Device for Diagnosing Technical Equipment

(76) Inventor: Michal Orkisz, Krakow (PL)

Correspondence Address: ABB INC.;LEGAL DEPARTMENT-4U6, 29801 EUCLID AVENUE, WICKLIFFE, OH, 44092, US

(21) Appl. No.: 11/659,632

(22) PCT Filed: Jul. 13, 2005
(86) PCT No.: PCT/PL05/00043

§ 371 Date: Jul. 6, 2007

(30) Foreign Application Priority Data
Aug. 9, 2004 (PL) P-369476

(51) Int. Cl. G06F 11/00

(52) U.S. Cl. 714/27

(57) ABSTRACT

The subject of the invention is a method and a device for diagnosing technical equipment, in which the equipment condition is assessed on the basis of the results of various technical verification tests. In this method the configuration of individual measuring tests is stored in separate templates, the component elements of the templates are compared, identical component elements are searched out, and then the templates are combined with each other and a new template is automatically generated, which contains, besides component elements specific for each individual template, also component elements common with at least one of the remaining templates. The device for implementing the inventive method has means of storing, comparing, combining component elements from different templates and automatically generating a new template which serves as the basis for creating a new type of the measuring test.

The subject of the invention is a method and a device for diagnosing technical equipment, in which assessment of equipment condition is based on the results of various technical verification tests run for a given piece of technical equipment or for different components of technical equipment.

After running a great number of technical verification tests for a piece of technical equipment or its components and after recording the results of those tests on a computer data carrier or storing in the storage of a computer device, a computer analysis of the test results is usually made, after which the condition of the piece of technical equipment is assessed by means of a suitable diagnosing software. If for a given piece of technical equipment a number of different tests can be run or several subassemblies can be tested, a problem appears, namely, how to manage the configuration of variable measurement data, constant properties, or alarms connected with those tests. It may happen that one piece of data is required for several tests. It may also happen that the results of one set of tests are required to perform calculations connected with other tests. Tracking interrelations between tests, adding, and especially removing a specific test involves therefore adding or removing a potentially large number of variables, constants and alarms, which is inconvenient, causes errors and makes modular designing of the system difficult. The invention solves the problem by eliminating or considerably lessening the difficulties connected with data configuration management for data obtained as a result of verification tests useful for technical equipment diagnosing.

The essence of the method for diagnosing technical equipment, in which the results of at least two measuring tests executed for a given piece of technical equipment are used, which results are processed in a computer device furnished with a computer program for diagnosing technical equipment is that the configuration of individual measuring tests is stored in separate templates, in the form of specific component elements, suitably grouped and defined, and then the component elements of each template are compared with the component elements from at least one other template and identical component elements from individual templates are searched out, and then the templates are combined with each other and a new template is generated automatically which, besides component elements specific for each individual template, contains also component elements common with at least one of the other templates, whereupon, on the basis of thus created template a new measuring test configuration is created, which is presented to the user as a simplified method for diagnosing technical equipment.

Preferably component elements are defined as constant parameters, input variables, intermediate results and alarms.

Preferably input variables are defined in the form of numbers, tables of numbers, text and/or images or sounds.

Preferably constant parameters are defined in the form of numerical or text data relating to the diagnosed technical equipment.

Preferably constant parameters are defined in the form of numerical or text data relating to the admissible limits of the normal operation of the diagnosed technical equipment.

Preferably identical component elements that are constant parameters are searched out from different templates.

Preferably identical component elements that are input variables are searched out from different templates.

Preferably identical component elements which are intermediate results and which correspond to the component elements that are the input variables of other templates are searched out from different templates.

The device for diagnosing technical equipment in which the results of measuring tests executed for a given piece of technical equipment are stored and subjected to computer processing, during which the type of variable and constant parameters connected with the measuring test under way are defined, furnished with a computer program for diagnosing technical equipment, is characterised in that it has:

means of storing, in separate templates, of defined component elements in the form of defined partial modules which contain definitions of the type of variable and constant parameters or calculations and alarms relating to a given test,

means of comparing stored component elements in order to determine which component elements for at least one template correspond to the same component elements for other templates,

means of combining identical component elements occurring in different templates,

means of automatically generating a new template by attaching other component elements remaining in at least one template to the combined identical component elements,

means of visualisation of the new measuring test created on the basis of the generated new template.

The advantage of the invention is that it allows to run the technical test configuration management process for tests useful in industrial diagnostics in a way which greatly simplifies the method for technical equipment diagnosing, by automatically generating such test configurations in a computer device, which will allow to execute the tests faster and to save the computation time of the diagnosing computer device, while maintaining high quality of the results of the diagnostic analysis.

The inventive method is shown by an embodiment example in the drawing where

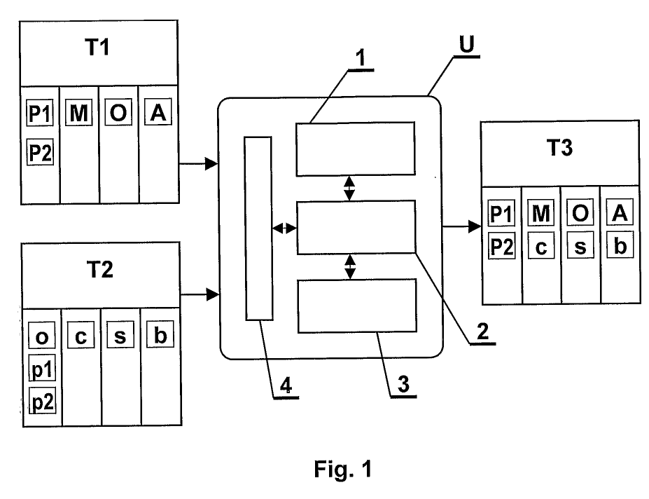

FIG. 1 shows a simplified block diagram of a typical computer device together with sample measuring test templates, computer-processed in this device, and

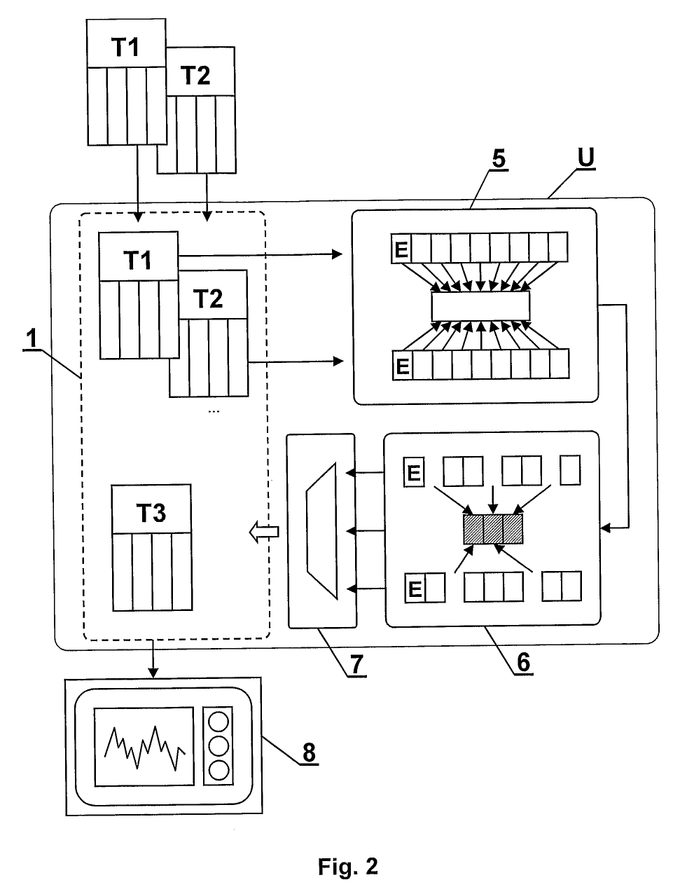

FIG. 2—a diagram of the device used to implement the inventive method.

In the invention embodiment, two measuring tests for a rotating machine, for example an electric motor, are executed by means of known measuring instruments. The purpose of the first measuring test is to determine the rotational speed of the rotating machine based on the measurement of the vibration of is specific subassemblies, and the second measuring test is to determine the condition of the rolling bearings of the rotating machine, also based on the measurement of the vibration of its specific subassemblies. For each measuring test separate templates T1 and T2 is defined. These templates are stored in the storage 1 of the computer device U. The computer device U contains the storage 1, a processor 2, a mass storage 3, a communications adapter 4 and a peripheral in the form of a keyboard, a mouse and a screen, or a printer, not shown in the drawing (FIG. 1).

The first template T1 is used to determine the rotational speed of the tested rotating machine on the basis of vibration measurement. The first two component elements in the form of variables, being the result of two types of input measurements relating to the equipment vibration time waveform measurement on the drive side—measurement P1, and on the non-drive side—measurement P2, are defined in this template. The constant characteristic of the test, i.e. the maximum rotational speed of the rotating machine M is defined as the third component element. The current resultant rotational speed O of the machine, which is the fourth component element, is obtained as a result of the completed test, on the basis of measured input data P1 and P2 and computer calculations made according to a specific algorithm delivered together with the diagnosing program implemented in the computer device. In the first template T1, as the fifth component element is defined also the alarm A which is signalled when the resultant rotational speed O exceeds the predefined maximum rotational speed M of the tested machine.

The function of the second template T2 is to determine the condition of the rolling bearing of the rotating machine. In this template, the rotating machine rolling bearing condition test is defined based on the measurement of the vibrations of the shaft supported by the tested bearings. The rotational speed of the shaft o is defined as the first component element containing input data, and vibration time waveforms p1 and p2 measured on the drive and non-drive sides of the machine—as the second and third component elements. As the fourth component element are defined constant characteristics, which are the characteristic frequencies c of defects of the bearings, expressed in the form of a multiple of the rotational speed. As the fifth component element s is defined a partial result which is a number describing the bearing condition, calculated on the basis of the input data, taking into consideration the frequencies of the bearing defects. As the sixth component element is defined the alarm b which is signalled when the bearing condition s exceeds the maximum allowable value, for instance 2.5.

From thus defined test templates, saved on a computer medium and supplied to the computer device U, after storing them in the computer memory in the form of component elements E, by means of a comparator module 5 for comparing the component elements E implemented in the processor, the component elements from both templates are compared. Next, in a module 6 that collects the templates and that is implemented in the processor, identical component elements E common for both templates are combined. In the next step, in a generator module 7 implemented in the processor, a separate test template T3 is generated. The way of creating the template T3 consists in such combination of the templates T1 and T2 that in the first place the input variables P1 and P2 from the first template T1 are identified with corresponding identical variables p1 and p2 from the second template T2. As a result of such combination of templates only two, and not four variables are defined, which significantly narrows down the number of data required for the measurement and allows to save the computing time of the computer device considerably. The resultant rotational speed O from the first template is identified with the input rotational speed o from the second template. As a result the current rotational speed of the shaft o does not need to be measured, since it is calculated using the algorithm delivered with the diagnosing program implemented in the computer device in the first template T1. The time needed for running the measuring test T2 can be reduced by abandoning the performance of the measurements of the current rotational speed of the shaft. As a result of measuring tests T1 and T2 two alarms are defined: one, A, relating to the rotational speed and derived from the first template T1 and the second, b, relating to the bearing condition, derived from the second template T2. Thereby the combined templates jointly define the input measurements, constant characteristics, results and alarms connected with the determination of the monitored equipment condition. The new test template T3 is presented to the computer device user by means of a typical device for visualising results 8. Then, by means of the processor of the computer device U, furnished with a suitable diagnosing program, the results of the tests are analysed in order to determine the condition of the tested device.

The purpose of the inventive method and device is to enable a modular approach to the configuration of technical equipment tests. The method is based on generating templates defining all variables, constant characteristics and alarms connected with a given test, for each type of test, and on an observation that in each test certain input data, certain constant characteristics, certain definitions of alarms can be involved and, additionally, intermediate results can be calculated and used. In each test template there are defined test input data, constant characteristics, calculations of intermediate data and alarms which are a result of a comparison of input data, constant characteristics and intermediate values. Messages transmitted to the user if a specific condition occurs or instructions determining actions to be taken in such event can also be defined in the templates. Individual test templates defined for a given piece of equipment can be combined by means of a module that collects test templates. All definitions relating to the same input variable, to the same constant characteristic etc. are combined in the template combining process. At the same time the calculated partial results of one template are identified with input data of another template, if possible.

1. A method for diagnosing technical equipment in which results of at least two measuring tests executed for a given piece of technical equipment are used, which results are processed in a computer device furnished with a computer program for diagnosing technical equipment, characterised in that the configuration of individual measuring tests is stored in separate templates, in the form of specific component elements, suitably grouped and defined, and then the component elements of each template are compared with the component elements from at least one other template and identical component elements from individual templates are searched out, and then templates are combined with each other and a new template is automatically generated which contains—besides component elements specific for each of the individual templates—also component elements common with at least one of the other templates, whereupon on the basis of the thus created template a new measuring test configuration is created which is presented to the user as a simplified method for diagnosing technical equipment.

2. A method according to claim 1 characterised in that component elements are defined as constant parameters, input variables, intermediate results and alarms.

3. A method according to claim 2 characterised in that input variables are defined in the form of numbers, tables of numbers, text and/or images or sounds.

4. A method according to claim 2 characterised in that constant parameters are defined in the form of numerical or text data relating to the diagnosed technical equipment.

5. A method according to claim 2 characterised in that constant parameters are defined in the form of numerical or text data relating to the admissible limits of normal operation of the diagnosed technical equipment.

6. A method according to claim 1 characterised in that identical component elements that are constant parameters are searched out from different templates.

7. A method according to claim 1 characterised in that identical component elements that are input variables are searched out from different templates.

8. A method according to claim 1 characterised in that identical component elements which are intermediate results and which correspond to component elements that are input variables of other templates are searched out from different templates.

9. A device for diagnosing technical equipment, in which the results of measuring tests executed for a given piece of technical equipment are stored and subjected to computer processing during which the type of variable and constant parameters connected with the measuring test under way are defined, furnished with a computer program for diagnosing technical equipment, characterised in that it has:
means of storing—in separate templates—defined component elements in the form of defined partial modules which contain definitions of the type of variable and constant parameters or calculations and alarms relating to a given test;
means of comparing stored component elements in order to determine which component elements for at least one template correspond to the same component elements for other templates;
means of combining identical component elements occurring in different templates;
means of automatically generating a new template by attaching other component elements remaining in at least one template to the combined identical component elements;
means of visualising a new measuring test created on the basis of a generated new template.
